(19) United States
(12) Patent Application Publication
(10) Pub. No.: US 2005/0140203 A1
(43) Pub. Date: Jun. 30, 2005

(54) Pedal mechanism

(76) Inventor: Erik Mannle, Oberkich (DE)

Correspondence Address: Mary R Bonzagni;Holland & Bonzagni, Suite 302, 171 Dwight Road, Longmeadow, MA, 01106-1700, US

(21) Appl. No.: 10/495,050

(22) PCT Filed: Nov. 6, 2002
(86) PCT No.: PCT/IB02/04925

(30) Foreign Application Priority Data
Nov. 6, 2001 (GB) 0126606.3

(51) Int. Cl. B60T 17/00

(52) U.S. Cl. 303/1

(57) ABSTRACT

A pedal mechanism (20) comprising a friction member comprising a column received at one end within the pedal arm (18), a friction element mounted on the other end of the column in frictional contact with a friction surface (36) on the base (23) and means (30, 32) for biasing the friction element (28a) in a direction towards the friction surface, the position of the friction element and column relative to the pivot axis (26) being such that as the pedal arm rotates about the pivot axis, the column is urged either away from the pedal arm by pressure between the friction element and the surface of the base or toward the pedal arm by the biasing means, to provide a resistance to rotational movement of the pedal in one rotational direction, and a restoring force assisting rotational movement of the pedal in the other rotational direction.

This invention relates to the field of pedal mechanisms, and in particular pedal mechanisms for use in ‘drive by wire’ systems (also referred to as electronic throttle control systems).

‘Drive by wire’ control systems are becoming more prevalent in vehicles. Rather than supplying a mechanical linkage between, for example, an accelerator pedal and a throttle valve an electrical signal is generated in response to the position of the accelerator pedal and this signal is transmitted to an electronic control system that uses this signal, along with others, to determine the response of the engine. Pedal arrangements for use with ‘drive by wire’ systems are known from, inter alia, EP-A-0 974 886 and European patent application 01303777.5.

According to a first aspect of the invention there is provided a pedal mechanism comprising a pedal arm mounted on a base for rotation about a pivot axis, and a friction mechanism mounted between the pedal arm and the base for resisting movement about the pivot axis in one rotational direction and for assisting movement in the other rotational direction, the friction mechanism comprising a friction member on the pedal arm, and a friction surface mounted on the base, the friction member being biased into contact with the friction surface and being mounted on the pedal arm for movement across the friction surface against the biasing force, and the position of the friction member and the friction surface relative to the pivot axis being such that as the pedal arm rotates about the pivot axis, the friction member is urged against the biasing force to provide a resistance to rotational movement of the pedal in one rotational direction, and a restoring force assisting rotational movement of the pedal in the other rotational direction, the friction member comprising a column received at one end within the pedal arm, a friction element mounted on the other end of the column in frictional contact with a friction surface on the base and means for biasing the friction element in a direction towards the friction surface, the position of the friction element and column relative to the pivot axis being such that as the pedal arm rotates about the pivot axis, the column is urged either away from the pedal arm by pressure between the friction element and the surface of the base or toward the pedal arm by the biasing means, to provide a resistance to rotational movement of the pedal in one rotational direction, and a restoring force assisting rotational movement of the pedal in the other rotational direction.

The advantage of this arrangement of the pedal mechanism is that the production is simplified as the column and friction element replace a piston within a cylinder which required significant effort to produce to strict dimensional tolerances.

The biasing means may comprise at least one helical compression spring in compression between the pedal arm and the friction element and preferably comprises two helical springs of different diameters with one spring fitted inside the other. An advantage of the present invention is that the replacement of the combination of piston and cylinder is that there is more space within which the springs can be fitted. This enables a smaller pedal mechanism to be made, facilitating its use within vehicles of a smaller size.

The ends of the biasing spring(s) may be located within respective annular grooves formed in the pedal arm and the friction element. The end of the friction element in contact with the base may be rounded.

Preferably, one end of the column is fixedly received in the pedal arm and the friction element is slideably received on the other end of the column. The friction element may comprise an annular sleeve that extends over a region of the column. Alternatively, one end of the column may be slideably received in the pedal arm with the friction element fixedly received on the other end of the column.

The invention will now be described, by way of example only, with reference to the following Figures in which:

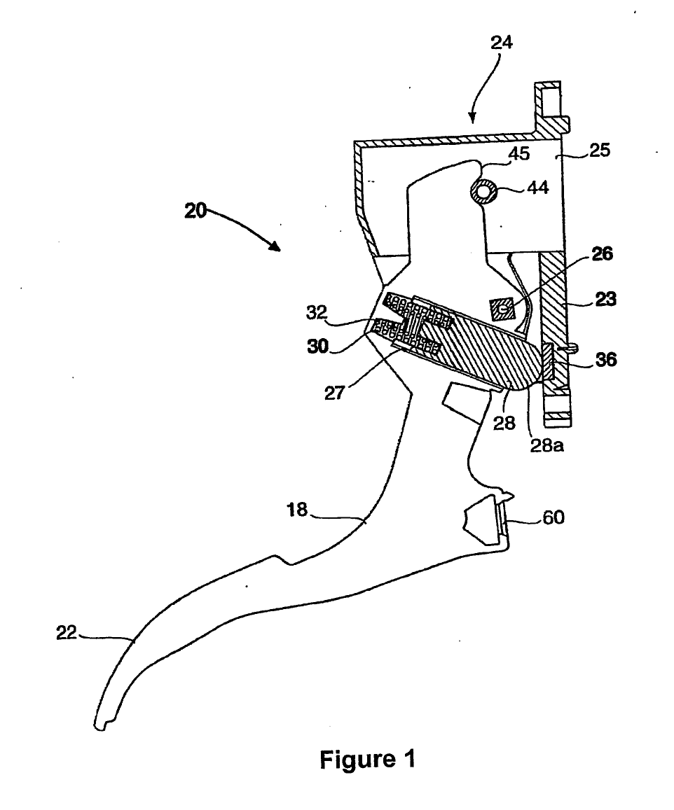

FIG. 1 shows a first schematic depiction of known pedal mechanism;

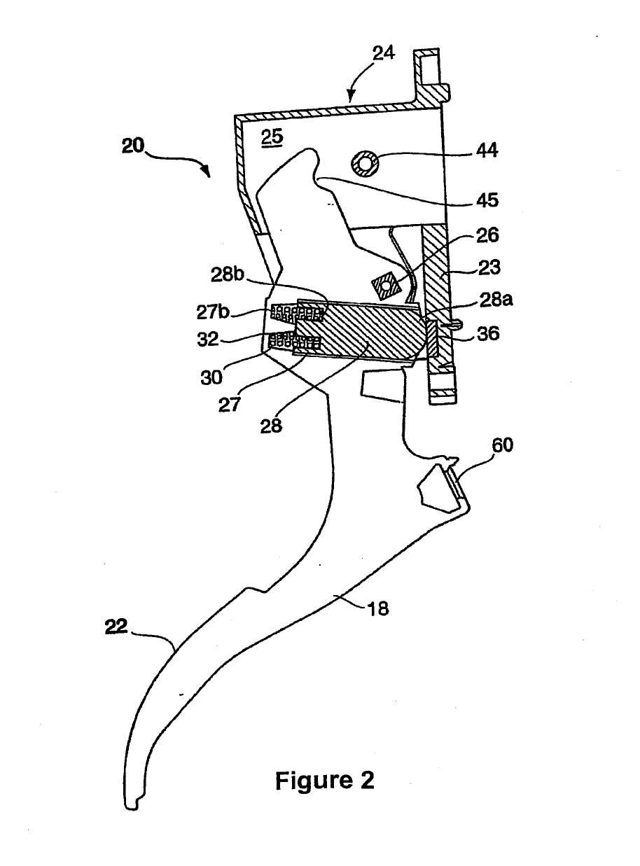

FIG. 2 shows a second schematic depiction of known pedal mechanism;

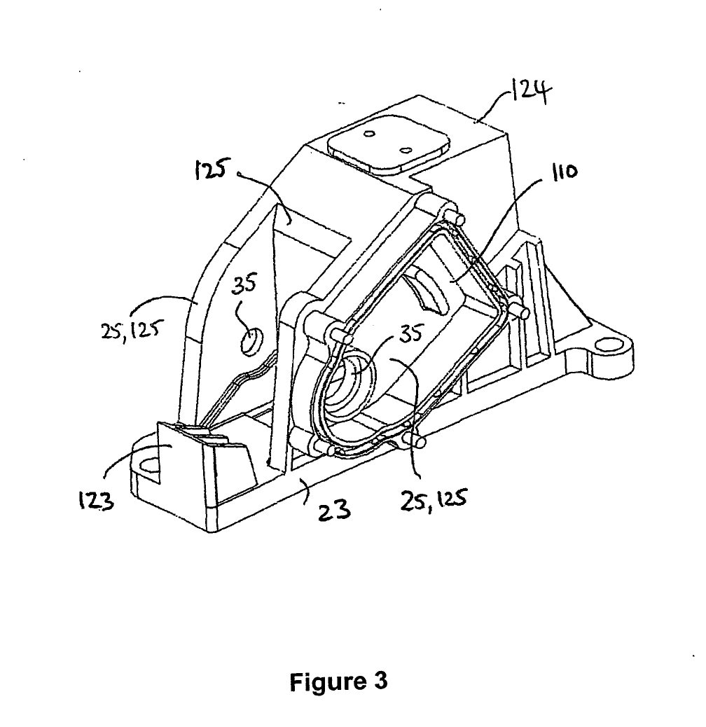

FIG. 3 shows a view of part of the pedal mechanism depicted in FIGS. 1 & 2;

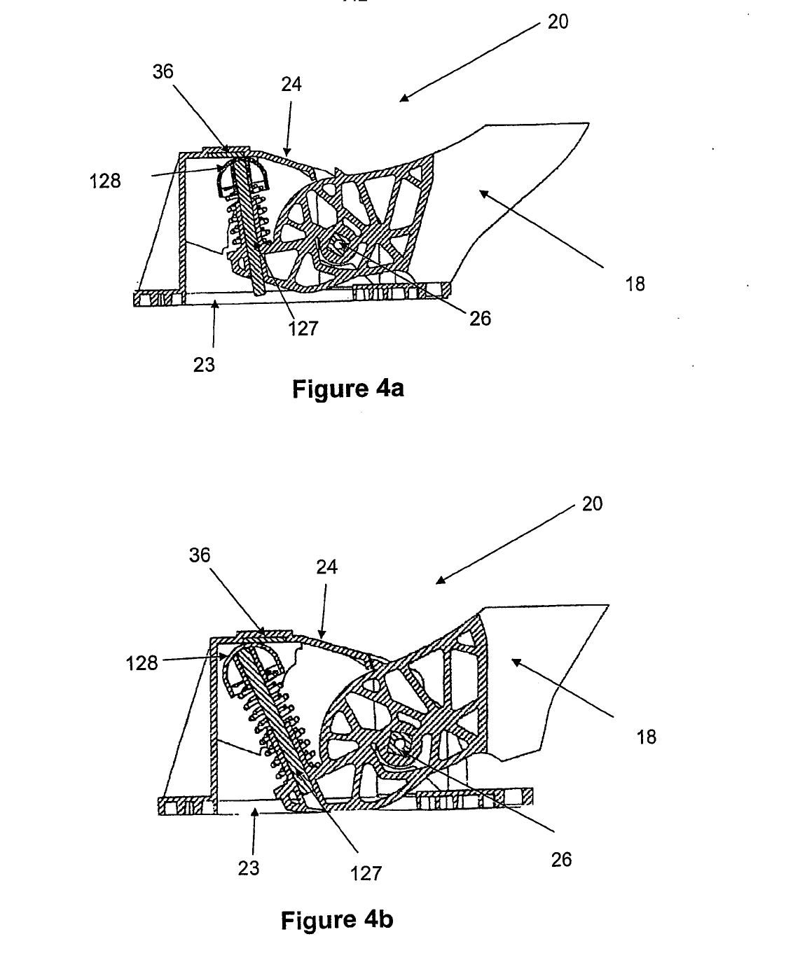

FIG. 4 shows an embodiment of a pedal mechanism according to the present invention; and

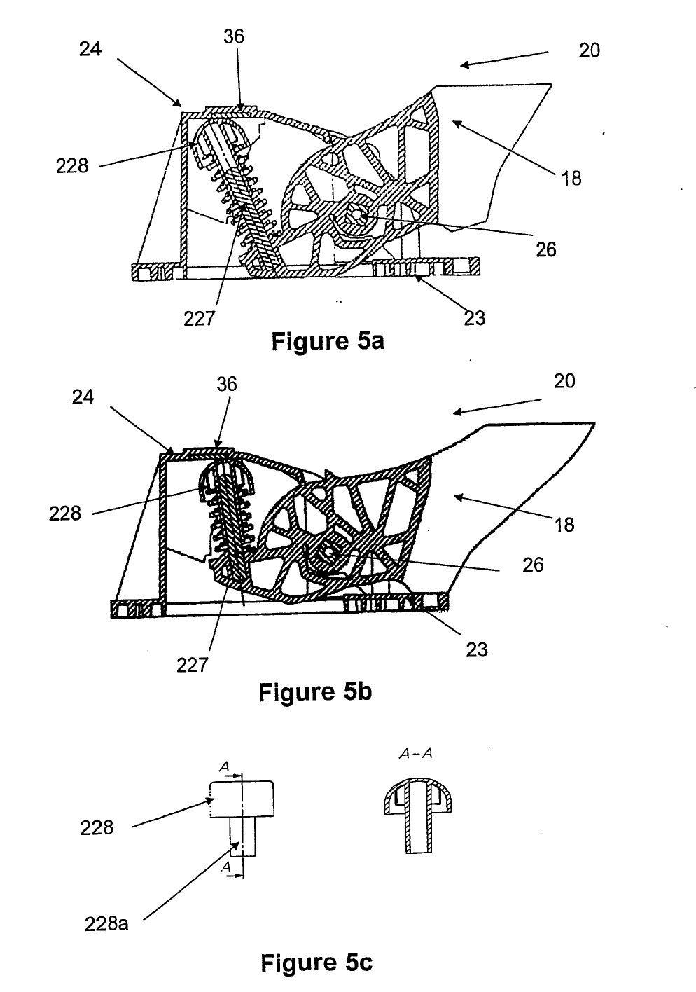

FIG. 5 shows a second embodiment of a pedal mechanism according to the present invention.

FIG. 1 to 3 show a known pedal mechanism 20. The pedal mechanism 20 has a pedal arm 18 which is mounted at one end in a housing 24 in order to pivot about a pedal spindle 26. The spindle 26 has a square section portion 27 which is received in a square section bore 37 and circular bearing portions 29 which are received in circular bearing sockets 35 in the side walls of the housing. At one end, the spindle has a head 31 with projecting, off-centre, pins 33 and a sensor wiper arm will be secured to these pins. As a result of this construction, as the pedal is pivoted about its axis, the spindle will turn in the bearing sockets 35 and the wiper arm will move relative to a fixed part of the sensor by a distance proportional to the angular movement of the pedal arm.

A pedal 22 is provided at the other end of the pedal arm 18 for contact with a driver's foot. The housing 24 has a base 23 which, in use, will be permanently mounted on the floor of a vehicle and which has oppositely facing upstanding walls 25, between which the pedal arm 18 is pivotally mounted.

The pedal arm 18 has a socket in the form of an open-ended cylinder 27 in which there is located a piston 28. The piston 28 can move in and out of the cylinder 27, along the cylinder axis. One end portion (referred to here as the friction member) 28a of the piston 28 projects to a point outside the cylinder and makes contact with a friction surface on the base 23 whilst the opposite end (referred to as the back end) 28b of the piston 28 always remains in the cylinder 27.

A resetting element in the form of a pair of helical compression springs 30,32 is mounted between the inner end of the cylinder 27 and the back end 28b of the piston 28. The helical springs have different diameters, and are nested one inside the other. Two springs, are used, so that even if one fails, the function will still be performed by the other. One end of the springs is located in an annular groove 27b formed in the inner end of the cylinder 27, whilst the other end of the springs is located in a corresponding annular groove in the back end 28b of the piston.

The helical springs 30,32 are always in compression between the back end 28b of the piston and the inner end of the cylinder and thereby bias, the front end 28a of the piston 28 into contact with the base 23, so that the pedal arm 18 is always urged in the direction of the rest or idle position of FIG. 2.

When the pedal arm is depressed by the driver's foot the angular movement of the pedal arm 18 towards the base plate 23 causes the piston 28 to move further into the cylinder 27, thereby further compressing the springs 30,32. The pedal can be moved to any position between the ‘idle’ position shown in FIG. 1 and the ‘full gas’ position shown in FIG. 2. During angular movement of the pedal arm, relative sliding movement takes place between the piston end, 28a and the base 23 which, in conjunction with the bias provided by the reset springs 30,32, produces a frictional force which will be felt as a resistance by the driver, when the pedal arm is depressed.

In the region where the piston 28 makes contact with the base 23, the base 23 has a friction surface 36, formed from a material which is chosen to produce, in conjunction with a friction surface, on the front end of the piston, a desired frictional force which will be felt by the driver when the pedal arm is depressed.

A stop 44 is provided between the upstanding walls 25 of the housing to limit the angular movement of the pedal 18. When the pedal 18 is released from the full gas position of FIG. 3 and reaches the idle position shown in FIG. 2, the stop 44 locates in a groove 45 of the pedal arm 18, thereby preventing any further clockwise angular movement of the pedal 18. The stop 44,45 is located on the side of the pedal spindle 26 opposite to the pedal 22.

The pedal mechanism 20 is assembled by inserting the springs 30,32 into the cylinder 27 in the pedal arm 18 so that they fit within the annular groove 27b, inserting the piston 18 into the cylinder 27 and fitting the pedal arm between the upstanding walls 25 of the housing 24. (A snap fit mechanism may be provided to prevent the piston 28 from falling out of the cylinder 27 whilst the pedal mechanism 20 is being assembled). The square section hole 37 in the pedal arm 18 is then lined up with the holes 35 in the side walls 25, and the spindle 26 is pushed into place through the holes to act as a bearing. To do this will require some compression of the springs 30,32, but the pedal mechanism 20 can be assembled in this way simply and without any tools.

FIG. 4 shows a schematic depiction of a pedal mechanism according to the present invention; FIG. 4a shows the pedal mechanism in the ‘idle’ position while FIG. 4b shows the pedal mechanism in the ‘full gas’ position.

Instead of the combination of piston 28 and cylinder 27 described above in reference in FIGS. 1 to 3, pedal mechanism 420 comprises a column 127 and cap 128. Column 127 is received at one end within a channel formed in pedal arm 18 and the other end of column 127 is connected to cap 128 which is in contact with the housing 24 opposite the base 23. A resetting element in the form of two helical compression springs is mounted between the column 127 and the cap 128. One end of the springs are received within a circular annulus formed within the cap 128 whilst the other end of the springs are secured in the pedal arm, coaxial to the channel in which the column 127 is received by the pedal arm. As the pedal is depressed, the pedal arm 81 acts to compress the springs 30,32 leading to an increase in the pressure felt by the driver. If the driver releases pressure from the pedal then the springs will extend, returning the pedal to its idle position. FIG. 4 shows that the outer end of the cap 128 now bears against a friction pad 36 arranged on a surface of the housing 24 which is opposite to the base 23. The contact surface between the piston and the pad is thus concealed within the housing and is less liable to pick up dirt or be covered in oil than is the case with the first embodiment. Furthermore, the upper surface of the pedal-arm is provided with walls which extend parallel to the pivot axis of the pedal and co-operate with an inwardly extending wall on the housing to form a labyrinth type seal to protect the interior of the housing 24 against the ingress of dirt or other substances which could affect the sliding contact between the cap 128 and the friction pad 136.

When the pedal connected to the pedal arm 18 is depressed, the cap 128 moves across the friction pad 36 such that the driver experiences a desired frictional force through the operation of the pedal. FIG. 4b shows the pedal arrangement at the fullest extent of the pedal travel, where the cap has reached the farthest extent of the friction pad.

The arrangement shown in FIGS. 1 and 2 and described above comprise a piston inserted within a cylinder, with two resetting springs being received around the piston and within the cylinder. In order to control the fit between the piston and the cylinder and to provide sufficient space to receive the resetting springs it is necessary for the piston and the cylinder to be manufactured to very high tolerances, adding to the complexity and cost of the production process. The use of a column 127, which may be, for example, a steel pin, simplifies the production of the pedal mechanism and provides more space for the resetting springs. This increase in space enables the use of shorter springs which in turn allows the pedal, mechanism to be reduced in size, enabling drive by wire systems to be fitted into smaller vehicles where the size of the pedal mechanism may be more significant.

FIG. 5 shows a schematic depiction of a pedal mechanism according to a second embodiment of the present invention; FIG. 5a shows the pedal-mechanism in the ‘idle’ position while FIG. 5b shows the pedal mechanism in the ‘full gas’ position. The pedal mechanism shown in FIG. 5 is substantially the same as that shown in FIG. 4 except that the column 227 is fixedly received within the pedal arm 18 such that there is no relative motion between the pedal arm 18 and the column 227. Resetting springs 30 and 32 are located around column 227 and act to urge the outer surface of the cap 228 towards the interior surface of the housing and the friction pad 36. The cap 228 additionally comprises an annular sleeve 228a within which the column 227 is slideably received. The length of the sleeve 228a is designed to be sufficient that the column is securely received within the sleeve at the ‘full gas’ position, i.e. the point at which the end of the column is farthest from the cap 228. FIG. 5c shows a sectional view and a cross-sectional view of the cap 228.

Advantageously the column is a steel pin, but it is preferred that that the column is moulded integrally with the rest of the pedal arm, further simplifying the production of the pedal assembly. The cap can be made of a similar material to the friction pad to give good tribologic properties that enable the pedal to be operated without any further lubricants such as grease. The embodiment described in FIG. 5 also has the advantages that the simplified design provides more space for the resetting springs, allowing pedal mechanisms of a reduced size.

The end of the cap in contact with the base will preferably be rounded, so as to reduce the dependence of the contact area on the angular position of the foot pedal and to improve the uniformity of the friction. The area of the base in contact with the cap will preferably be substantially flat, normal to the plane of movement of the foot pedal. The end of the cap may be rounded so that it is rotationally symmetric about the cap axis, or may be curved in only one plane, so that the cap end is in line contact, rather than point contact, with the surface of the base.

1. A pedal mechanism comprising a pedal arm mounted on a base for rotation about a pivot axis, and a friction mechanism mounted between the pedal arm and the base for resisting movement about the pivot axis in one rotational direction and for assisting movement in the other rotational direction, the friction mechanism comprising a friction member on the pedal arm, and a friction surface mounted on the base, the friction member being biased into contact with the friction surface and being mounted on the pedal arm for movement across the friction surface against the biasing force and the position of the friction member and the friction surface relative to the pivot axis being such that as the pedal arm rotates about the pivot axis, the friction member is urged against the biasing force to provide a resistance to rotational movement of the pedal in one rotational direction, and a restoring force assisting rotational movement of the pedal in the other rotational direction, the friction member comprising a column received at one end within the pedal arm, a friction element mounted on the other end of the column in frictional contact with a friction surface on the base and means for biasing the friction element in a direction towards the friction surface, the position of the friction element and column relative to the pivot axis being such that as the pedal arm rotates about the pivot axis, the column is urged either away from the pedal arm by pressure between the friction element and the surface of the base or toward the pedal arm by the biasing means, to provide a resistance to rotational movement of the pedal in one rotational direction, and a restoring force assisting rotational movement of the pedal in the other rotational direction, characterised in that one end of the column is fixedly received in the pedal arm and the friction element is slideably received on the other end of the column.

2. A pedal mechanism according to claim 1, wherein the friction element comprises an annular sleeve that extends over a region of the column.

3. A pedal mechanism according to claim 1 or claim 2, wherein the biasing means comprises at least one helical compression spring in compression between the pedal arm and the friction element.

4. A pedal mechanism according to claim 3, wherein the biasing means comprises two helical springs of different diameters with one spring fitted inside the other.

5. A pedal mechanism according to claim 3 or claim 4, wherein the ends of the biasing spring(s) are located within respective annular grooves formed in the pedal arm and the friction element.

6. A pedal mechanism according to any preceding claim 1, wherein the end of the friction element in contact with the base is rounded.

7. A pedal mechanism comprising a pedal arm mounted on a base for rotation about a pivot axis, and a friction mechanism mounted between the pedal arm and the base for resisting movement about the pivot axis in one rotational direction and for assisting movement in the other rotational direction, the friction mechanism comprising a friction member on the pedal arm, and a friction surface mounted on the base, the friction member being biased into contact with the friction surface and being mounted on the pedal arm for movement across the friction surface against the biasing force, and the position of the friction member and the friction surface relative to the pivot axis being such that as the pedal arm rotates about the pivot axis, the friction member is urged against the biasing force to provide a resistance to rotational movement of the pedal in one rotational direction, and a restoring force assisting rotational movement of the pedal in the other rotational direction, the friction member comprising a column received at one end within the pedal arm, a friction element mounted on the other end of the column in frictional contact with a friction surface on the base and means for biasing the friction element in a direction towards the friction surface, the position of the friction element and column relative to the pivot axis being such that as the pedal arm rotates about the pivot axis, the column is urged either away from the pedal arm by pressure between the friction element and the surface of the base or toward the pedal arm by the biasing means, to provide a resistance to rotational movement of the pedal in one rotational direction, and a restoring force assisting rotational movement of the pedal in the other rotational direction, characterised in that one end of the column is slideably received in the pedal arm and the friction element is fixedly received on the other end of the column.

8. A pedal mechanism according to claim 2, wherein the biasing means comprises at least one helical compression spring in compression between the pedal arm and the friction element.

9. A pedal mechanism according to claim 8, wherein the biasing means comprises two helical springs of different diameters with one spring fitted inside the other.

10. A pedal mechanism according to claim 8, wherein the ends of the biasing spring(s) are located within respective annular grooves formed in the pedal arm and the friction element.

11. A pedal mechanism according to claim 4, wherein the ends of the biasing spring(s) are located within respective annular grooves formed in the pedal arm and the friction element.

12. A pedal mechanism according to claim 9, wherein the ends of the biasing spring(s) are located within respective annular grooves formed in the pedal arm and the friction element.
